(19) United States
(12) Patent Application Publication
(10) Pub. No.: US 2025/0342496 A1
(43) Pub. Date: Nov. 6, 2025

(54) MULTI-PURPOSE INTERACTIVE SOCIAL PLATFORM AND METHOD OF USING THE SAME

(71) Applicant: Tamouh Alhakim, Abu Dhabi (AE)

(72) Inventor: Tamouh Alhakim, Abu Dhabi (AE)

(21) Appl. No.: 19/200,546

(22) Filed: May 6, 2025

Related U.S. Application Data
(60) Provisional application No. 63/642,962, filed on May 6, 2024.

(51) Int. Cl. G06Q 30/0207; G06Q 50/00

(52) U.S. Cl. CPC G06Q 30/0209; G06Q 30/0212; G06Q 50/01

(57) ABSTRACT

A social media platform facilitates user interaction through digital environments called “bubbles,” which serve as customizable, collaborative spaces for content sharing and engagement. Users can participate in gamified events such as challenges, races, and raffles within these bubbles. The platform incorporates a blockchain-based reward system that issues digital assets, including tokens and non-fungible tokens (NFTs), based on user participation and performance. Each piece of content shared within a bubble can be assigned its own privacy level, independent of the user's account settings. The system supports role-based access, content moderation, and smart contract integration to ensure secure, transparent reward distribution.

### CROSS-REFERENCE TO RELATED APPLICATIONS

This application claims the benefit of U.S. Provisional Patent Application No. 63/642,962, filed on May 6, 2024, the entire contents of which are incorporated herein by reference.

### TECHNICAL FIELD

The embodiments disclosed herein generally relate to social media platforms, and more specifically, to systems and methods that facilitate user interaction, content sharing, and digital collaboration through gamified experiences and blockchain-based rewards. The invention further introduces an innovative content privacy management mechanism distinct from user account privacy.

### BACKGROUND

Social networking platforms have become central to digital communication, enabling billions of users to share content, connect with peers, and engage with entertainment, education, and commerce. Since the emergence of popular social media platforms, the fundamental model of social media has emphasized user-generated content, profile-centric interactions, and passive consumption of updates. Over time, these platforms integrated multimedia features, messaging systems, and targeted advertising, cementing their role in daily life. However, this evolution has largely maintained a linear structure—users post content, others react, and engagement is measured by likes, shares, and comments.

In response to user fatigue and declining engagement, many platforms have explored gamification and content customization as ways to increase user retention. These efforts include badges, streaks, virtual goods, and limited-time events. While such features have proven effective in mobile games and fitness apps, their application in traditional social media often feels superficial or isolated from core user experiences. Moreover, these elements rarely facilitate deep or meaningful collaboration. Users are still largely engaging in siloed activities that revolve around self-promotion rather than interaction.

At the same time, technological advances such as blockchain, decentralized media storage, and token economies have introduced new possibilities for digital ownership and reward systems. Platforms in the Web3 space have experimented with decentralized content publishing and NFT integration. However, these systems frequently suffer from steep learning curves, fragmented user experiences, and limited appeal outside of crypto-enthusiast communities. The integration of blockchain into mainstream user applications remains challenging, particularly when it comes to balancing usability, scalability, and security.

Another major shortcoming in existing social media platforms lies in privacy management and user agency over shared content. Most systems offer a binary approach to visibility: either public or private, applied globally at the account level. There is little to no granularity for managing visibility of individual pieces of content or structuring access to specific audience subsets. This limits how users can tailor their content to different contexts or communities, and often leads to oversharing, under-sharing, or self-censorship.

Given these limitations, there is a pressing need for a social media system that merges dynamic collaboration, meaningful user interaction, and intelligent reward mechanisms. Such a system must go beyond profile-centric models and introduce new frameworks that foster community participation, content ownership, and shared experiences.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclosed an interactive social media platform that enables users to engage in dynamic, collaborative digital environments called “bubbles.” These bubbles function as flexible containers for social interaction, content sharing, and gamified experiences, offering users a more engaging and rewarding way to connect online. Unlike traditional social media platforms that rely on passive content consumption and limited interaction mechanisms, the invention is designed to foster real-time collaboration, user-driven challenges, and blockchain-powered incentives. By integrating privacy customization, smart contracts, and role-based access, the invention provides a modular framework for social engagement that adapts to a wide variety of use cases, from casual conversations to community-driven campaigns.

At its core, the system allows users to create and participate in “bubbles,” each of which serves as a digital space where multiple users can share multimedia content, initiate conversations, and participate in structured activities. Each bubble is associated with a unique set of properties such as theme, duration, accessibility, and membership roles. This modular structure provides a flexible alternative to static user feeds by allowing communities to form organically around topics, events, or shared interests.

A key feature of the platform is its gamification engine, which enables users to initiate and participate in interactive events such as content creation challenges, timed races, and randomized raffles. These events are governed by predefined parameters, such as duration, participation criteria, or performance metrics, that ensure fairness and engagement. Gamification not only increases user retention but also encourages constructive interaction and community growth. It transforms social interaction from a passive activity into a participatory and goal-oriented experience.

To further incentivize participation, the invention integrates a blockchain-based reward system that issues digital assets, such as cryptocurrency tokens or non-fungible tokens (NFTs), based on user engagement. These rewards are governed by smart contracts that transparently manage the issuance, transfer, and redemption of assets. The use of distributed ledger technology ensures that reward transactions are immutable, traceable, and secure. This blockchain integration provides users with tangible value for their contributions and enhances trust in the reward system.

Each bubble supports role-based access control, allowing users to assume different responsibilities such as creator, moderator, or participant. Creators can configure the rules, appearance, and goals of a bubble. Moderators are responsible for maintaining order, enforcing guidelines, and managing content. Participants engage in discussions, share media, and compete in events. These defined roles streamline management, encourage responsible behavior, and promote active participation.

Multimedia content, such as text posts, images, videos, and links, can be easily uploaded and shared within each bubble. Unlike traditional platforms where content visibility is tied to global account settings, the invention introduces content-specific privacy controls. Users can define visibility parameters for each piece of content, selecting whether it is public, private, friends-only, or restricted to members of a specific bubble. This granular approach gives users more control over their data and allows them to tailor their content for different audiences.

Bubbles can also include expiration metadata, allowing them to exist for a limited time before becoming inactive or archived. This feature is particularly useful for event-based interactions, temporary campaigns, or time-sensitive discussions. By creating a sense of urgency and focus, time-bound bubbles enhance engagement and reduce content fatigue.

The system includes a robust analytics engine that captures and evaluates user activity across bubbles. This engine supports real-time tracking of participation metrics, user growth, content virality, and engagement levels. These insights help bubble creators refine their strategies and allow the platform to offer tailored recommendations for future events or interactions.

To enhance user experience, the platform features real-time notification systems that alert users when bubbles are created, events are launched, or rewards are distributed. These notifications keep users informed and connected, even when they are not actively using the platform.

The platform also supports visual customization of bubbles, enabling creators to select themes, icons, and layouts that align with the purpose of the interaction. This personalization enhances the aesthetic appeal of each bubble and strengthens user identification with specific communities or causes.

Smart contract functionality plays a pivotal role in managing digital assets and enforcing rules. For instance, a bubble challenge may include a smart contract that specifies the criteria for winning, verifies user submissions, and automatically distributes rewards upon completion. This level of automation reduces administrative overhead and ensures that users are rewarded fairly and transparently.

Moderation is supported through both manual and automated tools. Bubble moderators can flag inappropriate content, mute disruptive users, or remove violative media. Simultaneously, a content filtering engine scans uploaded material to detect offensive language, spam, or violations of community guidelines. This hybrid moderation model balances user freedom with platform integrity.

The system's non-transitory computer-readable medium stores executable instructions for performing all of the above functionalities. It supports deployment across devices including smartphones, tablets, and desktops. This cross-platform compatibility ensures accessibility and a consistent user experience regardless of the device.

Overall, the invention represents a significant advancement in the field of social media by blending gamification, privacy engineering, and blockchain economics into a cohesive digital ecosystem. It addresses longstanding issues such as lack of user agency, limited engagement mechanisms, and ineffective reward systems. By empowering users to control their social environments, participate in structured challenges, and earn verifiable digital assets, the invention redefines the social media experience for the next generation of digital communities.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the application program in communication with the computing system, according to some embodiments; and

FIG. 3 illustrates a flowchart of a method for facilitating user interaction in a social media platform, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a multi-purpose interactive social platform utilizing user-defined digital spaces known as “bubbles.” This description outlines various embodiments of the invention, incorporating elements of gamification, blockchain reward systems, content privacy control, and user role management. Each component is described in detail to demonstrate how the invention delivers a unique and immersive user experience distinct from conventional social networking platforms.

The term “bubble,” as used herein, refers to a digital container or interactive environment hosted on a social media platform that enables user participation, content sharing, and collaborative events. Each bubble can be uniquely configured by its creator and includes adjustable access permissions, discussion threads, multimedia galleries, gamified challenges, expiration parameters, and logic for allocating digital rewards. Bubbles provide modular and purpose-specific forums that support structured social engagement within the platform.

In some examples, each bubble may have a unique or customizable title that is defined by the creator of the bubble to allow each bubble to be its own entity (e.g., such as a channel name which is associated with the bubble).

Users initiate the creation of bubbles through a dedicated interface within the application. During this process, users select parameters including bubble title, visibility (public, private, or invite-only), membership rules, and duration of activity. The creation interface may also allow configuration of default content filters, media upload restrictions, and gamification settings. This high degree of customization supports diverse use cases, such as classroom discussions, fan groups, time-bound campaigns, or collaborative creative projects.

In some embodiments, each bubble can include four types of privacy. This may include private, public, secret and community. Private is for only friends and followers, where it is owned and controlled by the bubble creator. A public bubble is visible to all users in the application, with limited access to collaboration via request. The creator of the bubble has some degree of control over the bubble and its privacy and mechanics. A secret bubble is only accessible to people invited to the bubble and the creator has full control over the Bubble. A community bubble is where a creator is only the author of the bubble and has no control over the bubble after creation, the bubble is accessible by all the community

Once a bubble is established, the platform's content engine enables users to upload and interact with various types of multimedia. Supported formats include static images, video clips, embedded web links, text, live video and events, PDF documents, and audio recordings. Users may organize content into categories or threads and utilize interactive elements such as polls or content ratings. The system's responsive layout ensures consistent presentation across devices, enhancing accessibility and user satisfaction.

Each bubble is governed by a set of participation rules that determine acceptable behavior, content moderation thresholds, and interaction dynamics. These rules may be established manually by the bubble creator or automatically through system-generated templates. Participants are encouraged to post original content, reply to others, react using emojis or icons, and engage in thematic discussions. Bubbles can be configured to support real-time chats or asynchronous forum-style dialogue, depending on their purpose and target audience.

To further encourage active participation, the platform features a robust gamification engine. This engine is responsible for managing competitive and collaborative events within bubbles, known collectively as gamified events. The primary types of events include Bubble Challenges, which involve content submissions evaluated for creativity or impact; Bubble Races, which reward users for timely actions; and Bubble Raffles, which select winners from a pool of eligible participants at random.

Each gamified event is defined by a set of parameters tailored to its specific format. These include start and end times, entry requirements, methods for evaluating performance, and reward categories. For example, a Bubble Challenge might be scored based on peer votes or moderator decisions, whereas a Bubble Race might rely on time-stamped interactions. The system uses these parameters to enforce event integrity, manage participant eligibility, and determine final outcomes.

The reward mechanism is managed through a blockchain integration module, which issues and tracks digital rewards. These digital rewards may include platform-specific cryptocurrency tokens, non-fungible tokens (NFTs), badge collectibles, or credits redeemable for in-app privileges. The distribution of rewards is governed by smart contracts to ensure transparency, automation, and security.

The term “digital reward” refers to any virtual asset granted to a user as a result of their interaction within a bubble. These rewards serve both as recognition and as economic incentives for user engagement. They may be used within the platform to unlock content, access premium bubbles, or enhance user profiles. Some rewards may be transferable to external blockchain systems, giving them value beyond the platform.

In some embodiments, external rewards may include sponsored rewards, promotional or advertisement placement rewards, loyalty points, monetary rewards, and digital assets. The sponsored rewards are by companies and individuals for products and services. The promotional or advertisement placement rewards are by companies that promote their products and services through rewards. The loyalty points allows users to exchange bubble earned points and tokens for external loyalty points to earn exclusive discounts and promotions with registered companies. The monetary rewards enable cash prizes such as cash, cryptocurrencies, etc. by companies and/or individuals. The digital assets includes NFTs or other digital assets.

Smart contracts are programmatic scripts deployed to a blockchain, designed to execute predetermined logic when specific conditions are met. In this system, smart contracts manage the issuance of digital rewards by verifying user eligibility and recording reward transactions on an immutable ledger. For instance, a contract may stipulate that the top three contributors in a bubble receive NFTs, and upon challenge completion, those NFTs are automatically minted and assigned.

Each bubble supports distinct user roles that define the level of access and responsibility within that space. These roles include the creator, moderator, and participant. The creator holds administrative privileges such as configuring bubble settings, managing users, and launching events. Moderators are appointed to enforce community guidelines, flag inappropriate content, and mediate disputes. Participants are general users who can consume content, contribute posts, and enter challenges.

The platform includes a privacy control engine that allows users to assign content-specific visibility settings. This means that each post, image, or file shared within a bubble can be individually marked as public, private, friends-only, or bubble-exclusive. Unlike conventional systems where privacy is applied at the account level, this model provides granular control over content distribution and audience targeting. Privacy may be customized to be extendable to account privacy, bubble privacy and/or content privacy.

The benefits of this privacy model are multifaceted. Users can engage freely within different bubbles without altering their global profile settings. For example, a user may share personal reflections within a private support group bubble while maintaining a more curated presence in a public topic-based bubble. This flexibility empowers users to manage their digital identity across varied social contexts.

Bubbles can be configured with expiration metadata that determines their active lifespan. This expiration can be time-based (e.g., after 72 hours), event-based (e.g., after a challenge ends), or manually triggered by the creator. Upon expiration, a bubble may enter a read-only state, be archived for future viewing, or be deleted from the system entirely. This feature supports event-driven interaction and limits the proliferation of stale or abandoned content.

The visual presentation of bubbles is customizable, allowing creators to select themes, icons, color schemes, and layout structures. This customization enhances the distinct identity of each bubble and supports branding for groups, campaigns, or communities. Custom visuals also assist users in navigating and identifying bubbles within their interface.

The system includes a real-time notification engine that alerts users to relevant updates. These notifications may include new content postings, event announcements, reward distributions, and bubble expirations. Notifications are delivered through in-app alerts, push notifications, and email, based on user preferences. This keeps participants engaged and informed without requiring constant app usage.

The blockchain ledger module is integral to the platform's reward system. It processes and validates all reward-related transactions, ensuring that digital rewards are issued fairly and in accordance with smart contract logic. Each transaction is cryptographically signed and permanently stored on a distributed ledger, enhancing trust and transparency.

Users are equipped with a digital wallet integrated into their profile. This wallet is capable of receiving, storing, and managing various forms of digital rewards. It supports viewing transaction history, claiming tokens, and initiating transfers to external addresses compatible with the relevant blockchain. The wallet plays a central role in empowering users to own and control the value generated by their platform contributions.

Moderation features include tools for flagging inappropriate content, reviewing user reports, muting disruptive participants, and executing temporary or permanent suspensions. These tools are accessible to moderators and creators within each bubble. The moderation interface is designed to be intuitive, enabling quick and fair resolution of behavioral issues.

The analytics module continuously monitors, and aggregates data related to user engagement, bubble activity, and event performance. Metrics include the number of posts, likes, challenge entries, reward claims, and retention rates. This data is presented through dashboards for bubble creators and administrators, enabling them to refine strategies, improve engagement, and reward high-value contributors.

Metadata tagging is applied to all user-generated content. Tags include the author's ID, timestamp, associated bubble ID, assigned privacy level, and engagement statistics. This metadata supports content sorting, recommendation algorithms, historical audits, and lifecycle tracking. It ensures that content can be properly managed and contextualized.

Data integrity and security are enforced throughout the platform using industry-standard practices. All user data and media are transmitted using end-to-end encryption. Access to sensitive functions is secured via multi-factor authentication and role-based permissions. Blockchain transactions use asymmetric cryptography to ensure authenticity and resistance to tampering.

The platform is accessible through both web and mobile interfaces. The backend infrastructure is cloud-hosted and includes containerized microservices, distributed databases, and load-balanced smart contract execution nodes. This architecture supports high availability, horizontal scalability, and rapid feature deployment.

All significant user interactions are recorded in an immutable audit log. This log includes bubble creation events, content postings, challenge results, and reward transactions. It serves as a valuable resource for compliance verification, dispute resolution, and transparency reporting. The audit log is encrypted and periodically backed up to ensure durability.

This comprehensive system offers a novel approach to social networking by integrating collaborative tools, personalized rewards, and advanced privacy controls into an intuitive platform. Users are empowered to create unique digital communities, participate in enriching events, and receive meaningful recognition for their engagement. The invention enables a more interactive, rewarding, and secure online experience that adapts to the evolving demands of digital communication.

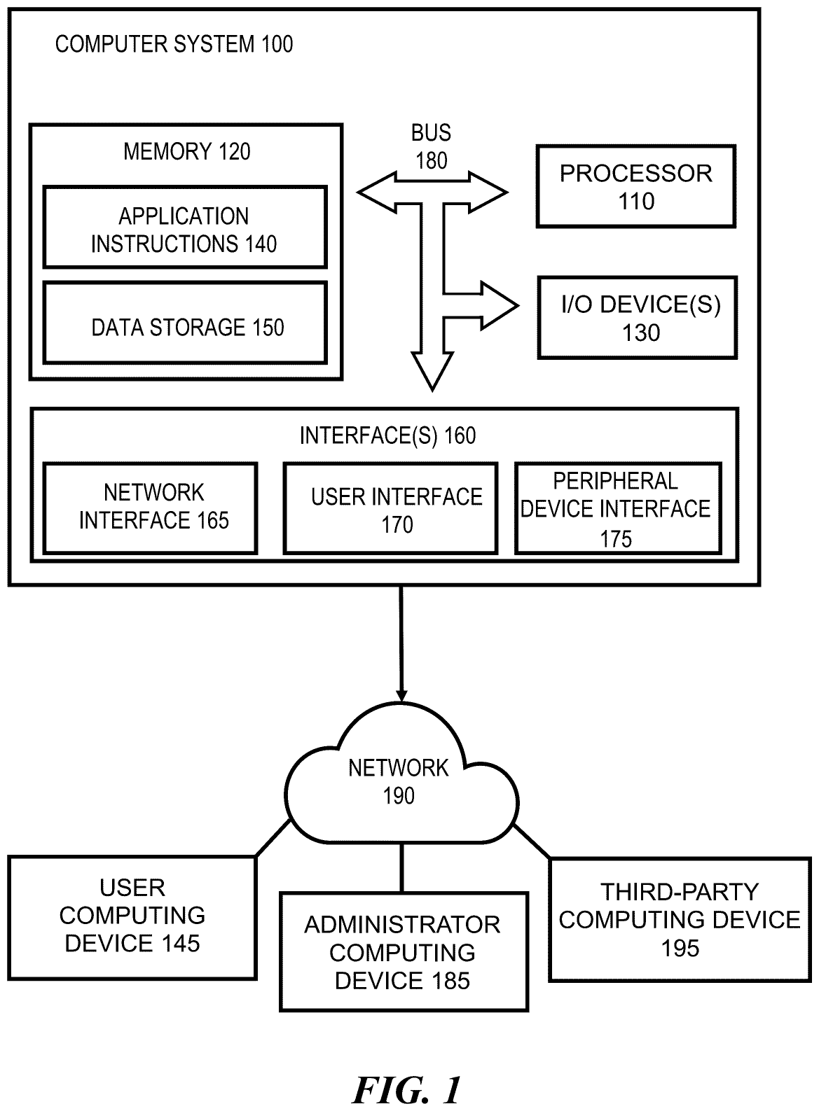

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

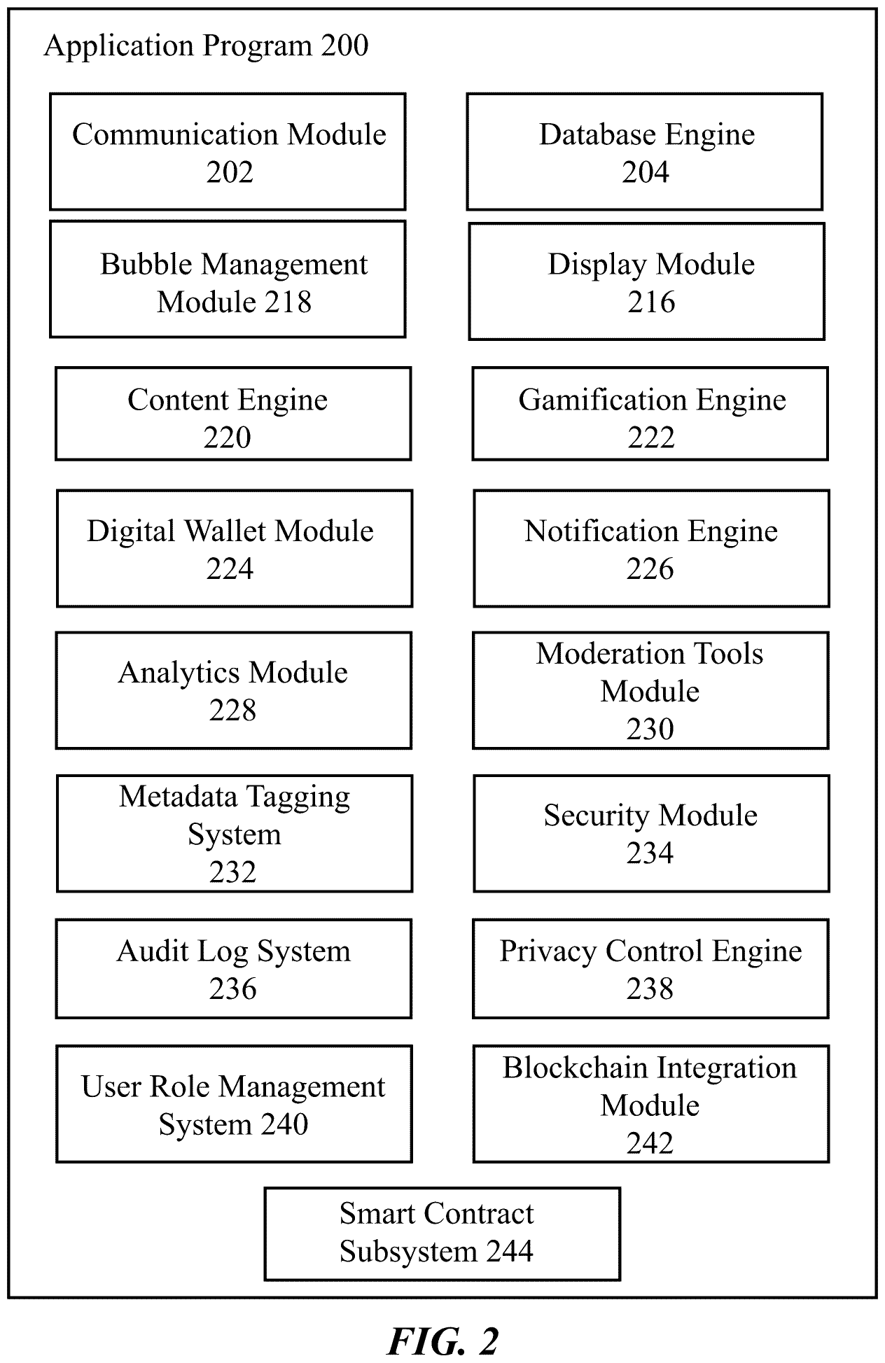

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a user module 212, a display module 216, a bubble management module 218, a content engine 220, a gamification engine 222, a digital wallet module 224, a notification engine 226, an analytics module 228, a moderation tools module 230, a metadata tagging system 232, a security module 234, an audit log system 236, a privacy control engine 238, a user role management system 240, a blockchain integration module 242, and a smart contract subsystem 244.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the user module 212 facilitates the creation of a user account for the application system. The user module 212 may allow the user to input account information, purchasing information, ordering details, shipping information, and the like.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user.

The bubble management module 218 serves as the orchestration system for user-generated interactive environments called “bubbles.” This module allows users to create, configure, and manage bubbles, which are modular digital collaboration spaces. The module stores and assigns unique bubble identifiers, and manages access rules, member lists, expiration metadata, and thematic configurations. The bubble management module communicates with the user module 212 to track role-based permissions and passes bubble state data to other components including the content engine 220, gamification engine 222, and notification engine 226.

The content engine 220 is responsible for the ingestion, rendering, and indexing of user-generated multimedia within bubbles. It supports uploads of text, images, audio, video, and links, each tagged with metadata through the metadata tagging system 232. The content engine 220 interfaces with the moderation tools module 230 to flag content, with the analytics module 228 to provide engagement metrics, and with the privacy control engine 238 to ensure appropriate access controls are applied. It dynamically formats content for display across devices and ensures compatibility with various file types.

The gamification engine 222 introduces game mechanics into the platform through events such as Bubble Challenges, Bubble Races, and Bubble Raffles. It uses user input and activity metrics collected by the content engine 220 and analytics module 228 to administer participation rules, track scores, and rank users. Upon event conclusion, the gamification engine 222 communicates with the blockchain integration module 242 and smart contract subsystem 244 to trigger reward issuance, such as NFTs or tokens, which are stored in the digital wallet module 224.

The digital wallet module 224 provides users with a secure interface for storing and managing digital assets such as tokens and NFTs. It receives updates from the blockchain integration module 242 following smart contract executions. The wallet module is integrated with the security module 234 for authentication, encryption, and fraud prevention, and is accessible via the user module 212.

The notification engine 226 delivers alerts triggered by user activity, content updates, gamification milestones, and role changes. It aggregates triggers from the bubble management module 218, gamification engine 222, and content engine 220, and dispatches messages via in-app, email, or push notifications based on user preferences stored by the user module 212.

The analytics module 228 collects data from every module within the system and visualizes this information through dashboards. It tracks engagement metrics, bubble growth trends, user reward histories, and system usage. This data informs automated recommendations, system optimization, and compliance monitoring.

The moderation tools module 230 allows authorized users to monitor and enforce platform policies. It includes reporting, flagging, and automated content filtering capabilities. It interacts closely with the content engine 220, user role management system 240, and audit log system 236.

The metadata tagging system 232 enriches all user content and interactions with structured metadata. This includes timestamps, user identifiers, content categories, event participation flags, and moderation status. Metadata enhances search, recommendation, moderation, and analytics functionalities.

The security module 234 governs access, authentication, and data protection for all system modules. It provides session management, role-based access enforcement, encryption protocols, and detection of unauthorized activity. It works closely with the audit log system 236 to log critical events.

The audit log system 236 captures a chronological, tamper-resistant record of all user actions and system operations. Each log entry includes module ID, user ID, action type, timestamp, and associated metadata. This module provides transparency, supports dispute resolution, and ensures regulatory compliance.

The privacy control engine 238 applies access rules to each piece of content or user activity based on its privacy designation. It supports bubble-level, content-level, and user-defined restrictions, ensuring that only authorized viewers can access or interact with protected data.

The user role management system 240 assigns, validates, and enforces user roles within each bubble and across the platform. Roles determine access levels to features, content, and moderation tools. It interacts with all functional modules to enforce permissions dynamically.

The blockchain integration module 242 interfaces with public and private blockchain networks to handle digital asset transactions, token minting, NFT storage, and reward verification. It receives inputs from the gamification engine 222 and communicates transaction results to the digital wallet module 224.

The smart contract subsystem 244 hosts reusable smart contracts used for automation of reward issuance, event validation, and access conditions. Contracts are invoked by the gamification engine 222 and blockchain integration module 242 and can include logic for dispute handling and rollback mechanisms.

Together, the modules 202 through 244 operate within a scalable backend infrastructure supported by the database engine 204 and display module 216, which respectively provide data persistence and user interface capabilities across computing system 100.

The Bubble Management Module is the foundational component responsible for the creation, configuration, and administration of user-defined interactive environments. These digital spaces, called “bubbles,” are modular units that allow users to gather around specific themes or activities. The module provides interfaces for naming, theming, defining access rules, setting expiration periods, and assigning participant roles.

Once a bubble is created, this module assigns a globally unique identifier (GUID) used across the platform for associating metadata, interactions, and access controls. This identifier is passed to various subsystems, such as the gamification engine and blockchain reward module, to facilitate inter-module communication. Additionally, the bubble state-including its active status, user membership, and visibility setting-is monitored and stored in real-time.

The Bubble Management Module communicates with the User Role Management System to grant or restrict permissions to users based on their assigned roles. For example, creators and moderators receive elevated privileges, while participants receive limited, interaction-focused access. The bubble's configuration parameters are also transmitted to the Notification Engine and Privacy Control Engine to ensure timely alerts and accurate enforcement of content visibility rules.

The Content Engine handles the ingestion, processing, and display of all user-generated content within bubbles. It accepts uploads of images, videos, text, hyperlinks, and embedded media, standardizing each item through a conversion layer that ensures compatibility across platforms. This engine tags each asset with metadata including the uploader ID, bubble ID, content type, file format, and timestamp.

The rendering subcomponent dynamically formats content for optimal display on various devices, whether desktop, tablet, or mobile. A real-time synchronization mechanism ensures that new posts or comments appear instantly within user sessions. The engine also supports threaded discussion formats, multimedia galleries, and reaction mechanisms such as likes, votes, and emoji responses.

The Content Engine interfaces with the Moderation Tools Module to detect and flag potentially harmful or inappropriate content. It also transmits engagement metrics, such as views or likes, to the Gamification Engine, which may use this data to determine event scoring. Furthermore, each interaction is logged and sent to the Audit Log System for compliance and transparency.

The Gamification Engine introduces game-based elements into user interactions to drive engagement and community activity. It hosts three primary event types: Bubble Challenges, Bubble Races, and Bubble Raffles. Each event type includes its own participation rules, scoring logic, and reward configuration. Additional games may be added such as bubble contests, awards, etc. User's may be given medals, rewards, etc.

This engine accepts input from the Content Engine to track user contributions, such as the number of posts or quality of engagement. Events can be launched manually by bubble creators or auto-triggered by predefined conditions, such as a threshold of user activity. The Gamification Engine maintains stateful data on ongoing and completed events, ranking users in real time.

Output from this engine feeds into the Blockchain Integration Module, where rewards are calculated and distributed. It also integrates with the Notification Engine to alert users when events begin, milestones are achieved, or winners are announced. Event templates can be customized by bubble creators, and smart contracts may be tied to each event for trustless reward execution.

The blockchain integration module is responsible for executing blockchain-based transactions and managing all digital rewards issued through the platform. It connects to one or more public or private blockchain networks to mint, store, and transfer non-fungible tokens (NFTs), platform tokens, or other digital assets.

Smart contracts deployed via this module codify the reward logic for gamified events. They are triggered by the Gamification Engine based on event outcomes and user rankings. Once a reward distribution is confirmed, this module generates a blockchain transaction that is recorded and timestamped for user reference.

It also interacts with the Digital Wallet module by broadcasting the issuance or receipt of assets. Security measures, such as cryptographic key verification and gas-fee estimation, are built into the transaction logic. The Blockchain Integration Module ensures tamper-proof, transparent accounting for all digital incentives issued on the platform.

Smart contracts are autonomous scripts deployed on a blockchain, governing specific platform behaviors such as event-based reward distribution. These contracts are defined in advance and include parameters such as eligible participants, reward thresholds, and expiration conditions.

When invoked by the Gamification Engine, a smart contract verifies the input data against its internal logic. If the conditions are met, the contract self-executes and updates the blockchain ledger. Contracts can also handle dispute logic, including automatic disqualification for rule violations or vote manipulation.

The system supports a library of reusable smart contract templates, which can be selected and parameterized by bubble creators. Each contract includes audit and rollback protections in case of system failures or contested outcomes. A record of smart contract activity is sent to the Audit Log System and Analytics Module for traceability.

The Digital Wallet module provides each user with a secure, in-platform vault for managing digital rewards and assets. Upon account creation, each user is assigned a wallet that integrates with external blockchain networks through API endpoints. Wallets store NFTs, tokens, and transaction histories.

Users can view their reward balances, initiate transfers, or export their assets to external wallets. Authentication mechanisms, including passphrase encryption and two-factor authentication, protect access to wallet functions. The wallet also logs transaction confirmations, asset valuations, and contract addresses for each asset.

The wallet interfaces with the Blockchain Integration Module to receive updates when new tokens or NFTs are issued. It also provides input to the Analytics Module to support visualizations of user reward behavior and contribution history. Through the wallet, users gain meaningful ownership over their contributions and earnings on the platform.

The user role management system determines the access level and permissions of each user within a bubble or across the platform. Supported roles include creator, moderator, and participant. The role assignment affects the user's ability to post, delete, manage events, moderate content, and configure bubble settings.

When a user is added to a bubble, this system checks against default permissions and platform policies. It logs all role changes and emits signals to other modules, such as the Notification Engine or Content Engine, to reflect updated access rights. A user's role also determines their eligibility for certain gamification features and moderation tools.

Administrators may adjust role hierarchies or override permissions in cases of abuse or platform-wide changes. Each user's role status is cached in memory for quick access and also stored persistently in the database. This system ensures that access control is enforced consistently across all modules.

The Privacy Control Engine allows content visibility to be defined at a granular level. Users can mark individual posts, media files, or comments as public, friends-only, bubble-limited, or private. This engine ensures that only authorized users may view or interact with restricted content.

When content is uploaded, the Content Engine passes it through the Privacy Control Engine to apply the correct visibility rules. These rules are based on both user-selected settings and inherited bubble configurations. The engine also checks user roles and connection graphs (e.g., friend relationships) to determine eligibility.

In cases of content resharing or event participation, the engine re-evaluates privacy rules to prevent unauthorized distribution. It logs all access checks and violations and works in conjunction with the Moderation Tools to quarantine breached content. This subsystem is essential for maintaining user trust and platform compliance.

The Notification Engine is responsible for alerting users to platform events, including bubble invitations, new content postings, reward distributions, and system updates. It integrates with all core modules, including the Bubble Management Module, Gamification Engine, Blockchain Integration Module, and Content Engine, to listen for event triggers. These triggers are converted into actionable notifications that can be configured based on user preferences.

Notifications may be delivered through in-app popups, mobile push notifications, SMS, or email. The delivery logic selects the most appropriate channel based on urgency, user presence, and platform settings. For example, notifications for gamified event deadlines may trigger mobile alerts, while content mentions might only appear within the application.

Each notification includes metadata such as the event source, timestamp, related bubble ID, and user-specific routing preferences. These attributes are logged by the Audit Log System to ensure transparency and accountability. The Notification Engine also supports grouped and batched notifications, reducing noise in high-activity bubbles.

Users can customize their notification settings via a dedicated interface. These settings control frequency, channel preferences, and do-not-disturb windows. The engine respects these configurations during message dispatch. Users may also opt into or out of specific notification types at the bubble or global level.

The Notification Engine interacts with the Analytics Module to track open rates, user response times, and conversion metrics. This data supports the optimization of engagement strategies and helps bubble creators measure the effectiveness of their communication.

The Analytics Module collects, processes, and visualizes data from across the platform to support informed decision-making and system optimization. It pulls data from the Content Engine, Gamification Engine, Blockchain Integration Module, Notification Engine, and User Role Management System.

For each bubble, the module tracks metrics such as the number of posts, reactions, new participants, and challenge entries. It can segment activity by time, role, or media type to provide granular insights. Bubble creators and platform administrators access these metrics through dashboards and downloadable reports.

The module also supports user-level analytics, capturing participation patterns, contribution quality, reward earnings, and responsiveness. These metrics are valuable for recommending bubbles to users, suggesting challenges, or evaluating moderation needs. Privacy policies govern the scope and use of this data.

Data collected by the Analytics Module is stored in a time-series database optimized for querying trends and anomalies. The module includes real-time charting engines and supports export to external systems for advanced data science use cases. It also feeds engagement signals to recommendation engines or ranking algorithms.

The Analytics Module is essential for maintaining transparency, enabling data-informed governance, and optimizing platform mechanics. It supports proactive intervention in stagnant or toxic bubbles and helps reward high-value contributors.

The Moderation Tools Module provides functionality for maintaining safe and constructive interactions within bubbles. It enables moderators and administrators to perform content reviews, enforce guidelines, and manage user behavior.

Features include content flagging, auto-moderation filters, user muting, content removal, warning issuance, and account suspension. These tools can be triggered manually or automatically, based on rule violations detected by the Content Engine or reported by other users.

The Moderation Tools Module integrates with the User Role Management System to verify authority before executing any action. Moderation events are logged to the Audit Log System for accountability. Each action includes a justification field, timestamp, and affected user list.

Auto-moderation filters use keyword matching, behavioral pattern detection, and machine learning classifiers to detect harmful or disruptive content. These filters are customizable by bubble creators or platform-level admins. Actions taken by auto-moderation are reviewed post hoc by human moderators to minimize false positives.

User reports are triaged and prioritized based on severity, frequency, and reporter trust level. The Moderation Tools Module includes a dashboard for reviewing active cases, communicating with involved parties, and resolving disputes. Escalation workflows support coordination with legal or compliance teams when needed.

The Metadata Tagging System ensures that all content and interactions are contextually annotated for efficient processing, search, and compliance. Each piece of content uploaded to a bubble is assigned metadata including the author's ID, timestamp, file type, privacy level, associated bubble ID, and engagement metrics.

This metadata supports search filtering, personalized recommendations, audit trails, and performance tracking. For example, content tagged as “challenge entry” can be automatically included in a gamified event. Tags such as “flagged” or “review pending” help guide moderation workflows.

Metadata is stored in a relational database and indexed for real-time access. Updates to tags are versioned and linked to user actions, supporting traceability. This structure allows for reconstruction of past content states and enables platform-wide consistency.

The tagging system also supports user-defined labels and smart tagging rules. For example, a bubble focused on product feedback may auto-tag all posts with attached images as “review candidates.” These automations reduce administrative overhead and improve data quality.

Integration with the Analytics Module allows for statistical analysis of metadata patterns. Administrators can monitor trends, such as increased content volume on specific topics or regions and adjust platform strategies accordingly.

The Security and Authentication Subsystem enforces identity verification, data protection, and secure access throughout the platform. It is composed of multi-factor authentication services, token-based session management, encryption libraries, and access control lists.

When users log in, they must pass authentication checks that may include passwords, biometric verification, or one-time codes. Upon successful login, a session token is issued and validated on subsequent requests. This token is encrypted and includes claims about the user's role, permissions, and active bubbles.

The subsystem enforces secure transport protocols for all data, using TLS encryption for client-server communication. Content uploads are scanned for malware and sanitized before storage. Sensitive data, including user credentials and wallet keys, are encrypted at rest using industry-standard algorithms.

Access control lists are dynamically evaluated based on user roles, bubble configuration, and content visibility rules. These lists are cached for performance and invalidated upon role or permission updates. The subsystem logs all access attempts and detects anomalous behavior such as credential stuffing or privilege escalation.

Security alerts are routed to the Notification Engine and may trigger automatic protective actions, such as session termination or temporary account lockout. The subsystem also supports periodic security audits and integrates with external identity providers via OAuth or SAML protocols.

The Audit Log System is a tamper-resistant recordkeeping mechanism for tracking significant user and system actions across the platform. Each log entry includes a timestamp, user ID, action type, target entity, and relevant metadata. Logs are digitally signed and stored in a secure, append-only format.

The system receives input from all modules, including the Content Engine, Moderation Tools, Blockchain Integration Module, and Notification Engine. It records actions such as content posting, reward issuance, role changes, and moderation outcomes. These logs provide a chronological account of events for internal review, user transparency, or external audits.

Administrators can query the audit log to reconstruct the state of a bubble at any point in time. This capability is critical for resolving disputes, identifying abuse, and demonstrating compliance with legal requirements. Logs are retained for a configurable duration and may be exported for offline storage or legal submission.

The Audit Log System includes access controls to restrict log visibility and editing. Viewing privileges are limited to users with appropriate roles or case involvement. Attempted modifications or deletions of logs are blocked and reported to the Security Subsystem.

To enhance performance, the system supports incremental indexing and real-time streaming of high-priority log events. It also integrates with external SIEM (Security Information and Event Management) tools for advanced threat detection and compliance analytics.

The backend infrastructure of the platform is designed for scalability, reliability, and maintainability. It is composed of containerized microservices, distributed data stores, and blockchain integration nodes deployed across cloud environments. Each core module described above runs as an isolated service with defined APIs for communication.

A service discovery mechanism and API gateway manage inter-service communication, load balancing, and fault tolerance. This architecture supports rolling updates, horizontal scaling, and dynamic resource allocation based on usage patterns. Logging, monitoring, and tracing tools ensure observability and rapid issue resolution.

The infrastructure includes persistent storage for content, metadata, and user data, backed by distributed databases with replication and failover. Caching layers improve performance for high-traffic endpoints. Static assets are served via a content delivery network (CDN) to optimize global access.

Blockchain-related operations are handled by dedicated nodes connected to public or permissioned chains. These nodes are monitored for health, latency, and transaction throughput. Smart contract deployment and transaction signing occur in secure enclaves to protect private keys.

Infrastructure security is maintained through network segmentation, access restrictions, and automated patching. Compliance with data protection regulations such as GDPR and CCPA is enforced through region-aware data policies and audit controls. The infrastructure supports both web and mobile clients, enabling broad platform accessibility.

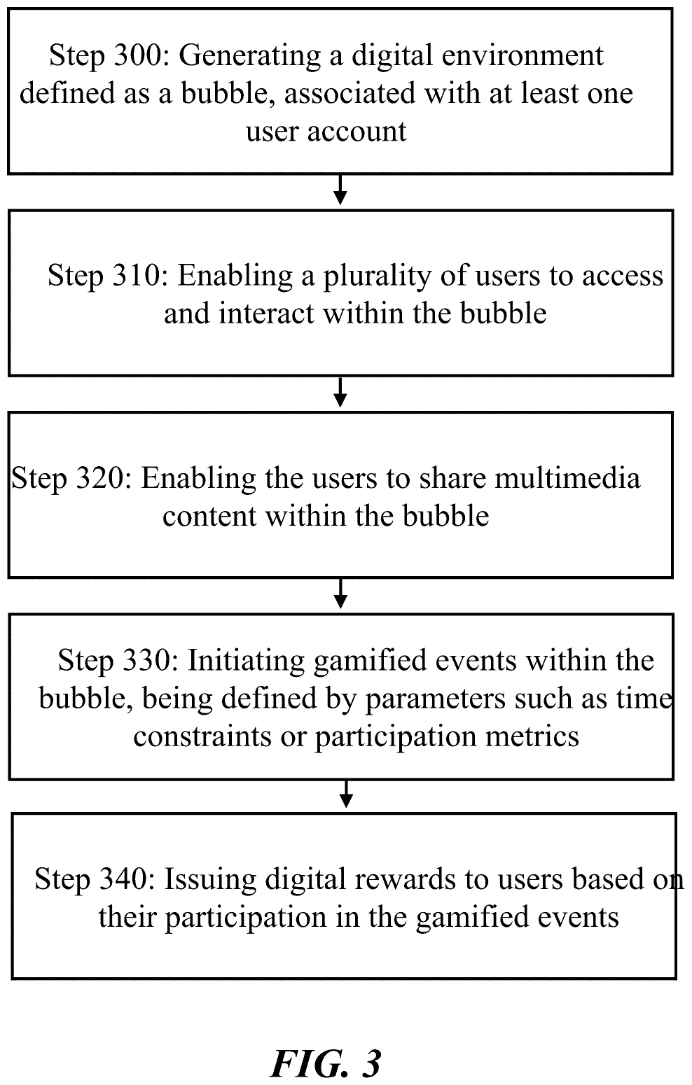

Referring now to FIG. 3, a flowchart illustrates a representative method executed by the application program for facilitating user interaction through a bubble-based environment. The process begins at Step 300 where a user initiates the creation of a digital environment, referred to as a bubble, via the user module and bubble management module. The user provides parameters such as bubble name, topic, access rules, and intended duration. Upon confirmation, the bubble management module assigns a unique identifier to the new bubble and stores the configuration in the database engine.

In Step 302, the system enables a plurality of users to join the created bubble. Access is granted based on invitations or visibility settings processed by the user role management system and privacy control engine. Role assignments such as creator, moderator, or participant are enforced, and each user is authenticated through the security module before interaction privileges are granted.

Step 304 involves enabling users to share multimedia content within the bubble. The content engine receives uploads and manages display formatting. Shared content is automatically tagged by the metadata tagging system, moderated by the moderation tools module, and subject to privacy filtering by the privacy control engine. Engagement data, such as views and reactions, is forwarded to the analytics module.

In Step 306, the bubble creator or the gamification engine initiates one or more gamified events within the bubble. These may include Bubble Challenges, Bubble Races, or Bubble Raffles. The gamification engine defines event rules, monitors participation using analytics from module, and calculates performance metrics. Participants engage based on conditions displayed through the display module.

Step 308 entails the issuance of digital rewards to qualifying users. The gamification engine transmits event results to the smart contract subsystem, which verifies outcomes and triggers reward minting through the blockchain integration module. Once created, these rewards, such as tokens or NFTs, are transferred to users' accounts and made accessible in their digital wallet module.

Throughout this process, supporting modules such as the notification engine provide timely alerts at key points, including bubble creation, event launches, and reward distributions. The audit log system captures a permanent record of each major action, supporting both transparency and compliance. The security module monitors all stages to ensure transaction integrity, access control enforcement, and data protection.

In alternative embodiments of the invention, various design, implementation, and architectural modifications may be introduced to expand the scope of protection and further differentiate the platform's collaborative, privacy, gamification, and blockchain elements, while maintaining the system's novel bubble-based interaction model.

In some embodiment, the gamification engine may incorporate a dynamic reward optimization algorithm that uses reinforcement learning to adjust event parameters and rewards in real-time based on user engagement trends. Unlike systems relying on static point thresholds or manual calibration, this machine learning-based framework may adapt to user preferences, content types, or regional behaviors, increasing platform stickiness and personalization.

The system may also include tiered bubble structures that allow parent-child relationships between bubbles. For example, a community-wide bubble may serve as a container for several sub-bubbles, each governed by distinct moderators or themes. This hierarchical model enables multi-layered content organization and governance and may facilitate large-scale collaboration across institutions, fanbases, or professional groups.

Another embodiment may utilize zero-knowledge proofs or privacy-preserving blockchain frameworks to secure user participation data while still allowing reward eligibility verification. For instance, users may anonymously participate in sensitive bubbles while still earning rewards, which are issued via smart contracts that only verify cryptographic hashes without accessing the underlying user data. This further enhances the invention's privacy model.

Bubbles may also incorporate access tokens or invite-only credentials that dynamically expire or renew based on behavior, allowing entry into exclusive content ecosystems that mimic subscription models or progressive unlock systems. These temporary access credentials can be paired with NFTs or smart badges, increasing the value and exclusivity of high-performing or premium bubbles.

In yet another embodiment, the invention could integrate a real-world action verification system via wearable devices or mobile sensors. Users may earn rewards for geofenced activity, like visiting physical landmarks or attending events. This “proof-of-presence” layer expands gamified participation to physical locations and real-world interaction.

The display module may be modified to support adaptive visual interfaces, where the bubble interface changes layout, hierarchy, or feature visibility depending on user interaction patterns or event status. For example, during live events, content may be reordered by activity, while archival bubbles may shift to a chronological document view. This dynamic UI enhances usability for diverse user types.

As another embodiment, the reward system could incorporate interoperability with external platforms. Smart contracts may issue dual-format rewards: one set of tokens compatible with internal gamification tiers and another compliant with decentralized finance (DeFi) protocols. This dual-layer approach could help users exchange engagement tokens for yield farming or staking products, offering financial utility beyond entertainment.

In certain embodiments, users may link their bubbles to third-party applications or APIs. For example, a bubble may sync with a code repository for software development teams, a real-time collaborative document for academic circles, or streaming software for content creators. These integrations would allow bubbles to serve as operational workspaces rather than just discussion environments.

A specialized scoring engine may be introduced to address quality of engagement, not just volume. User actions may be assigned weighted values based on originality, peer validation, or time sensitivity. These weighted scores can influence user ranks, bubble access, or reward eligibility, improving upon simple activity counters.

In a distinct embodiment, the platform could implement tokenized bubble ownership tiers where a bubble's control is partially decentralized. Users may purchase fractional stakes in bubbles and participate in governance decisions, such as moderator selection or feature priorities. This DAO-inspired model allows community-driven evolution and monetization of the most active social environments.

Furthermore, certain implementations may eliminate the need for centralized moderation entirely in specific bubbles. Instead, a decentralized reputation engine could automatically assign moderation privileges to users based on score history, community votes, or dispute resolution outcomes. This system may include dynamic delegation contracts that can be revoked via smart contract voting.

The geospatial discovery module may be extended to include augmented reality overlays, allowing users to view local bubbles superimposed over real-world views via their camera. This embodiment would allow discovery of location-linked conversations, events, or local promotions, creating a bridge between digital and physical social engagement.

Finally, to accommodate regions with limited connectivity or blockchain access, the platform may deploy a hybrid ledger system. User actions may first be recorded locally and batch-processed onto the blockchain asynchronously once bandwidth allows. This preserves integrity and compatibility while broadening global accessibility.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A computer-implemented method for facilitating user interaction in a social media platform, the method comprising the steps of:
generating a digital environment defined as a bubble, associated with at least one user account;
enabling a plurality of users to access and interact within the bubble;
enabling the users to share multimedia content within the bubble;
initiating gamified events within the bubble, the events being defined by parameters such as time constraints or participation metrics; and
issuing digital rewards to one or more users based on their participation in the gamified events.

2. The method of claim 1, wherein the digital rewards include blockchain-based tokens redeemable within the platform ecosystem.

3. The method of claim 1, wherein the gamified events include a bubble race requiring users to perform a predefined action faster than other participants.

4. The method of claim 1, wherein the gamified events include a randomized bubble raffle wherein winners are selected from eligible users based on engagement.

5. The method of claim 1, further comprising assigning user roles within a bubble, selected from the group consisting of creator, moderator, and participant.

6. The method of claim 1, wherein multimedia content includes text, video, images, hyperlinks, or embedded third-party content.

7. The method of claim 1, wherein each bubble includes expiration metadata defining a duration of activity after which the bubble becomes archived.

8. The method of claim 1, wherein users receive achievement badges or NFT collectibles upon completion of specific bubble milestones.

9. A social media platform system, comprising:
a server configured to manage a plurality of user accounts and digital bubbles;
a user interface module configured to allow users to create, join, and interact within said bubbles;
a gamification engine for hosting events selected from the group consisting of content challenges, races, and raffles;
a blockchain-based reward module configured to issue tokens, non-fungible tokens (NFTs), or cryptocurrency based on user interactions; and
a privacy control engine configured to assign content-specific visibility settings independent of user account-wide settings.

10. The system of claim 9, wherein the gamification engine is further configured to dynamically adjust event difficulty based on user participation rates.

11. The system of claim 9, wherein the privacy control engine permits setting visibility levels for each piece of content as public, private, friends-only, or bubble-limited.

12. The system of claim 9, wherein the blockchain-based reward module interfaces with a smart contract deployed on a public or private distributed ledger.

13. The system of claim 9, further comprising an analytics engine configured to generate user engagement reports based on bubble activity.

14. The system of claim 9, wherein the user interface module includes tools for customizing the appearance, theme, and rules of each bubble.

15. A non-transitory computer-readable medium storing instructions that, when executed by one or more processors, cause a computing device to perform a method comprising:
receiving user input to create a bubble within a social media application;
enabling content submission and collaborative interaction within the bubble by other users;
recording user engagement and performance metrics associated with bubble-related tasks;
distributing digital assets to users based on predefined rules governing the bubble activities; and
maintaining a cryptographic record of the issued rewards on a distributed ledger.

16. The system of claim 15, wherein the instructions further cause the device to provide real-time notifications to users upon triggering gamified events.

17. The system of claim 15, wherein the cryptographic record includes a hash of the engagement activity and the corresponding user identifier.

18. The system of claim 15, wherein the method includes validating user participation before issuing a reward, based on integrity constraints defined by a smart contract.

19. The system of claim 15, wherein the content submission step includes automated moderation using a content filtering engine.

20. The system of claim 15, wherein bubble-related tasks include collaborative creation of multimedia projects with attribution tracking.

21. Comments on additional claims that could be considered
